(19) United States
(12) Patent Application Publication
(10) Pub. No.: US 2026/0134299 A1
(43) Pub. Date: May 14, 2026

(54) AUTOMATIC QUESTION GENERATION APPARATUS AND METHOD

(71) Applicant: ELECTRONICS AND TELECOMMUNICATIONS RESEARCH INSTITUTE, Daejeon (KR)

(72) Inventor: Mi-Young CHO, Daejeon (KR)

(21) Appl. No.: 18/985,389

(22) Filed: Dec. 18, 2024

(30) Foreign Application Priority Data
Nov. 11, 2024 (KR) 10-2024-0159251

(51) Int. Cl. G06N 5/022

(52) U.S. Cl. CPC G06N 5/022

(57) ABSTRACT

Disclosed herein are an automatic question generation apparatus and method. The automatic question generation method includes detecting uncertainty by identifying presence or non-presence of missing knowledge and content of the missing knowledge based on environment information and conversation content, as uncertainty is detected, selecting a knowledge type for the missing knowledge, selecting a question type corresponding to the selected knowledge type, and generating a question by combining the knowledge type with the question type.

### CROSS REFERENCE TO RELATED APPLICATION

This application claims the benefit of Korean Patent Application No. 10-2024-0159251, filed Nov. 11, 2024, which is hereby incorporated by reference in its entirety into this application.

### BACKGROUND OF THE INVENTION

### 1. Technical Field

The following embodiments relate to technology in which an intelligent agent or a robot recognize uncertainty during a conversation with a person and automatically generate a question to resolve such uncertainty.

### 2. Description of Related Art

With the development of artificial intelligence and a Large Language Model (LLM), conversations between an agent/robot and a person (human) have become much more natural. Unlike existing methods in which only responses to a person's questions were possible, the agent or the robot has evolved to independently generate questions. That is, this means that questioning has been traditionally considered to be a uniquely human domain based on cognition and reasoning, but this boundary dissolves with the advancement of LLMs.

However, despite the advancement of LLMs, debates still remain regarding the optimal timing for asking questions, the appropriateness of a method of asking certain questions, etc.

Additionally, previously frequently utilized technology for conversations with an intelligent agent or a robot represents a query-response form relied only on rule-based preset sentences in specific situations, thus leading to monotonous interactions. Also, the technology is problematic in that it is impossible to respond appropriately to unexpected situations, that is, uncertainty, thus ultimately requiring a person's intervention to resolve such uncertainty.

### SUMMARY OF THE INVENTION

An embodiment is intended to allow an intelligent agent or a robot to determine a time point, at which a question is required, and conversation content and to automatically generate a question so as to resolve uncertainty, thus enabling responses suitable for a current situation, rather than making monochrome conversations based on preset rules.

An embodiment is intended to continue to exchange queries and responses based on a question model based on a human question process, unlike a rule-based model, even in an unpredictable situation, thus minimizing a person's intervention.

In accordance with an aspect, there is provided an automatic question generation method, including detecting uncertainty by identifying presence or non-presence of missing knowledge and content of the missing knowledge based on environment information and conversation content through task planning, as uncertainty is detected, selecting a knowledge type for the missing knowledge, selecting a question type corresponding to the selected knowledge type, and generating a question by combining the knowledge type with the question type.

Detecting the uncertainty may include creating detailed procedures for processing a requirement of a user based on the conversation content and the environment information, calculating confidence based on a probability of at least one output candidate for each procedure included in the created detailed procedures, and determining occurrence of missing knowledge based on the calculated confidence.

Calculating the confidence may include calculating the confidence of the corresponding procedure depending on whether the probability of the at least one output candidate is equal to or greater than a preset threshold or whether a difference value between probabilities of multiple output candidates is equal to or greater than a preset value.

Selecting the knowledge type may include inputting the missing knowledge and preset knowledge type information to a large language model and searching for an optimal knowledge type through the large language model.

Selecting the question type may include selecting the question type based on a probability of deriving the selected knowledge type from among preset question types.

Generating the question may include inputting information about the selected knowledge type and information about the selected question type to a large language model through a prompt, and automatically generating a question through the large language model, and the prompt may include instruction that is a target of a task, context that is background information of the task, input data that is a command of the user, and an output indicator that is a question sentence.

The automatic question generation method may further include after the generated question is output, analyzing an answer input from the user, and determining whether the answer satisfies the knowledge type.

Determining whether the answer satisfies the knowledge type may include determining whether the answer satisfies the knowledge type depending on whether a keyword found in the answer input from the user matches one of detailed procedures for processing the requirement of the user.

The automatic question generation method may further include, when the answer input from the user does not satisfy the knowledge type, re-performing a process starting from selecting the question type, wherein re-performing selecting the question type includes selecting a next question type in descending order of probabilities of deriving selected knowledge types from among preset question types.

The automatic question generation method may further include re-performing a process starting from selecting the knowledge type as missing knowledge is detected in the answer input from the user.

In accordance with another aspect, there is provided an automatic question generation apparatus, including memory configured to store at least one program, and a processor configured to execute the program, wherein the program is configured to detect uncertainty by identifying presence or non-presence of missing knowledge and content of the missing knowledge based on environment information and conversation content, as uncertainty is detected, select a knowledge type for the missing knowledge, select a question type corresponding to the selected knowledge type, and generate a question by combining the knowledge type with the question type.

The program may be configured to, in detecting the uncertainty, create detailed procedures for processing a requirement of a user based on the conversation content and the environment information through task planning, calculate confidence based on a probability of at least one output candidate for each procedure included in the created detailed procedures, and determine occurrence of missing knowledge based on the calculated confidence.

The program may be configured to, in calculating the confidence, calculate the confidence of the corresponding procedure depending on whether the probability of the at least one output candidate is equal to or greater than a preset threshold or whether a difference value between probabilities of multiple output candidates is equal to or greater than a preset value.

The program may be configured to, in selecting the knowledge type, input the missing knowledge and preset knowledge type information to a large language model and search for an optimal knowledge type through the large language model.

The program may be configured to, in selecting the question type, select the question type based on a probability of deriving the selected knowledge type from among preset question types.

The program may be configured to, in generating the question, input information about the selected knowledge type and information about the selected question type to a large language model through a prompt, and automatically generate a question through the large language model, and the prompt may include instruction that is a target of a task, context that is background information of the task, input data that is a command of the user, and an output indicator that is a question sentence.

The program may be configured to, after the generated question is output, analyze an answer input from the user, and determine whether the answer satisfies the knowledge type, and determine whether the answer satisfies the knowledge type depending on whether a keyword found in the answer input from the user matches one of detailed procedures for processing the requirement of the user.

The program may be configured to, when the answer input from the user does not satisfy the knowledge type, re-perform a process starting from selecting the question type, and in re-performing selecting the question type, select a next question type in descending order of probabilities of deriving selected knowledge types from among preset question types.

The program may be configured to re-perform a process starting from selecting the knowledge type as missing knowledge is detected in the answer input from the user.

In accordance with a further aspect, there is provided an automatic question generation method, including creating detailed procedures for processing a requirement of a user based on conversation content and environment information, calculating confidence based on a probability of at least one output candidate for each procedure included in the created detailed procedures, determining occurrence of missing knowledge based on the calculated confidence, as uncertainty is detected, selecting a knowledge type for the missing knowledge using a large language model, selecting a corresponding question type based on a probability of deriving the selected knowledge type, generating a question by combining the knowledge type with the question type, after the generated question is output, analyzing an answer input from the user, and determining whether the answer satisfies the knowledge type, and when the answer satisfies the knowledge type, detecting presence or non-presence of additional missing knowledge in the answer input from the user, wherein when the answer input from the user does not satisfy the knowledge type, a process starting from selecting the question type is re-performed, and wherein when additional missing knowledge is detected in the answer input from the user, a process starting from selecting the knowledge type is re-performed.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating a cognition process for question generation;

FIG. 2 is a flowchart for explaining an automatic question generation method according to an embodiment;

FIG. 3 is a flowchart for explaining in detail the step of detecting uncertainty according to an embodiment;

FIGS. 4 and 5 are diagrams illustrating an example of capturing of missing knowledge according to an embodiment;

FIG. 6 is a diagram for explaining the flow of the step of selecting a knowledge type corresponding to missing knowledge according to an embodiment;

FIG. 7 is a diagram illustrating an example of selection of a knowledge type corresponding to missing knowledge according to an embodiment;

FIGS. 8 and 9 are diagrams illustrating an example of selection of a question type according to an embodiment;

FIG. 10 is a diagram for explaining the step of generating a question based on K-type and Q-type according to an embodiment;

FIG. 11 is a diagram for explaining the step of determining whether K-types of a question and an answer match each other according to an embodiment;

FIG. 12 is a diagram illustrating an example of the case where an answer satisfies K-type for missing knowledge according to an embodiment;

FIG. 13 is a diagram illustrating an example of the case where an answer does not satisfy K-type for missing knowledge according to an embodiment;

FIG. 14 is a diagram illustrating an example of a process of re-selecting Q-type and generating an additional question when an answer does not satisfy K-type according to an embodiment;

FIG. 15 is a diagram illustrating an example of selection of K-type for added missing knowledge according to an embodiment;

FIG. 16 is a diagram illustrating an example of generation of an additional question based on additionally selected K-type and Q-type information; and

FIG. 17 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

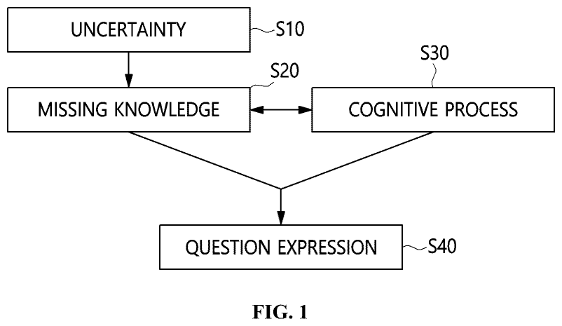

FIG. 1 is a diagram for explaining a cognitive process for question generation.

Research into questions is examined from the standpoint of cognitive science in educational fields with reference to FIG. 1. That is, the cognitive process may be summarized as follows. In detail, when a person encounters uncertainty at step S10, a cognitive process for question generation captures a missing knowledge element that causes uncertainty at step S20, the cognitive process to be performed to find the missing knowledge element is identified at step S30, and thereafter a question is asked using a language expression for efficiently deriving required information at step S40.

Here, missing knowledge refers to the direct target of a question, and is an element including content such as whether the identity of the question is uncertain and whether causality is uncertain. Further, the question expression may indicate various question forms, for example, a form in which a question corresponding to ‘yes/no’ is to be asked or a form in which a question such as ‘why’ is to be asked, in a language form.

The following embodiments are intended to propose an apparatus and method for detecting uncertainty in a situation in which an intelligent agent or a robot is conversing with a person based on the human question process such as that illustrated in FIG. 1, and automatically generating a question so as to resolve such uncertainty.

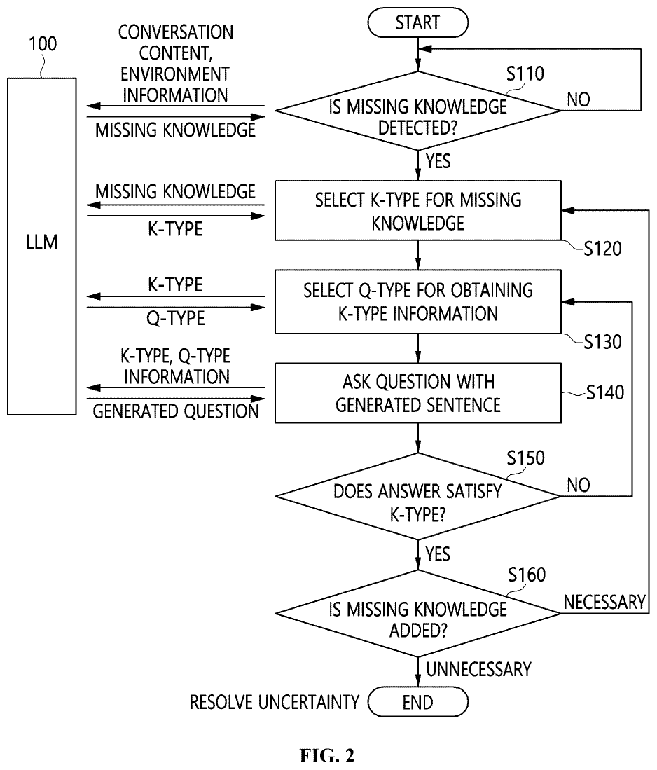

FIG. 2 is a flowchart for explaining an automatic question generation method according to an embodiment.

Referring to FIG. 2, the automatic question generation method according to the embodiment may include step S110 of detecting uncertainty by identifying presence/non-presence of missing knowledge and content of the missing knowledge based on environment information and conversation content, step S120 of selecting a knowledge type (K-type) for the missing knowledge as uncertainty is detected, step S130 of selecting a question type (Q-type) corresponding to the selected knowledge type (K-type), and step S140 of generating a question by combining the knowledge type (K-type) with the question type (Q-type).

Here, steps S110 to S140 may be performed in conjunction with a Large Language Model (LLM) 100.

Here, the Large Language Model (LLM) 100 is an Artificial Intelligence (AI) model trained to understand and generate a large-scale human language, and is utilized for a natural language processing task based on a deep learning algorithm and statistical modeling. Such an LLM 100 may learn large-scale language data to understand sentence structures, grammar, and semantics, and interact in a natural conversational form, unlike existing language models that learn predefined patterns, structures, and relationships within a given language scope.

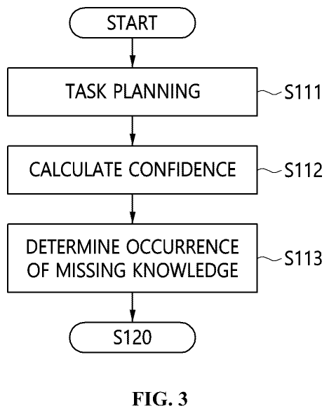

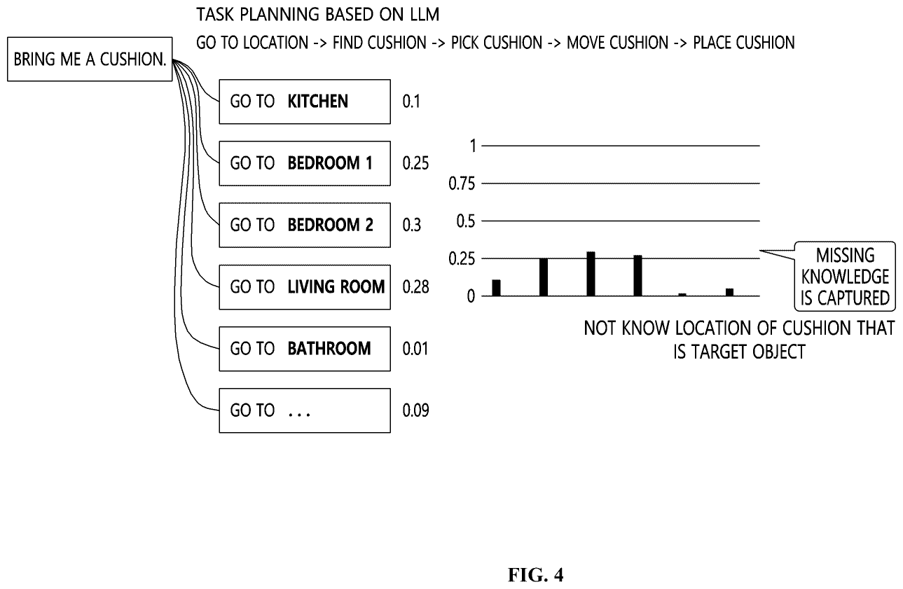

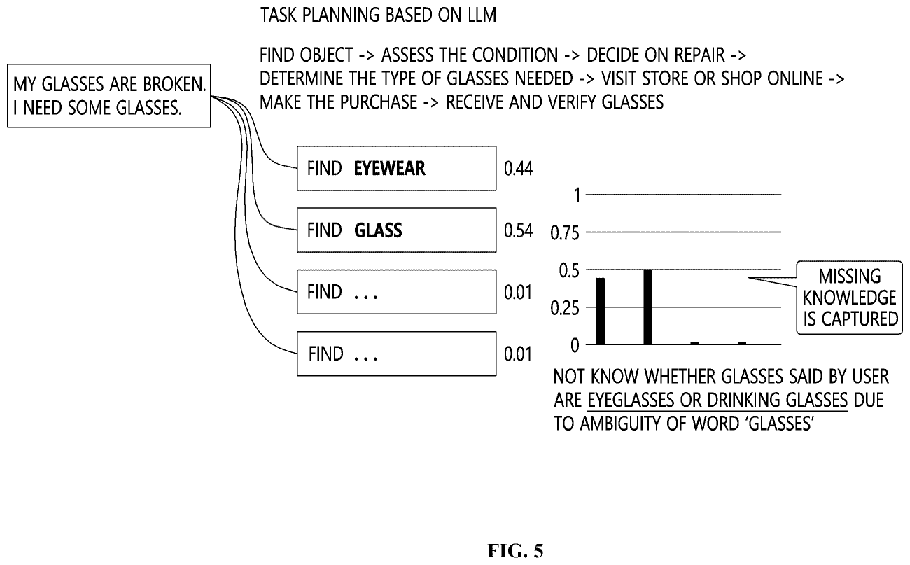

FIG. 3 is a flowchart for explaining in detail the step of detecting uncertainty according to an embodiment, and FIGS. 4 and 5 are diagrams illustrating an example of capturing of missing knowledge according to an embodiment.

Referring to FIG. 3, an intelligent agent or a robot creates a detailed procedure for processing the requirement of a user depending on conversation content and environment information, through task planning based on the LLM 100, at step S111.

For example, as shown in FIG. 4, in order to process the user's requirement such as ‘Bring me a cushion’, the intelligent agent or the robot creates detailed procedures to be performed in the following order through task planning based on the LLM.
1. Go to location
2. Find cushion
3. Pick cushion
4. Move cushion
5. Place cushion

Alternatively, as shown in FIG. 5, in order to process the user's requirement such as ‘My glasses are broken. I need some glasses’, the intelligent agent or the robot creates detailed procedures to be performed in the following order based on the LLM.
1. Find glasses
2. Assess the condition
3. Decide on repair
4. Determine the type of glasses needed
5. Visit store or shop online
6. Make the purchase
7. Receive and verify glasses

Thereafter, the intelligent agent or the robot calculates confidence based on the probability of at least one output candidate for each procedure included in the created detailed procedures at step S112.

For example, as shown in FIG. 4, “0.1”, “0.25”, etc. indicating the probabilities of “Go to kitchen”, “Go to bedroom 1”, etc., which are respective output candidates of “1. Go to location” included in the detailed procedures are calculated.

Further, as illustrated in FIG. 5, “0.44”, “0.54”, etc. indicating the probabilities of “Find eyewear”, “Find glass”, etc., which are respective output candidates of “1. Find glasses” included in the detailed procedures are calculated.

Here, step S112 of calculating confidence may calculate the confidence of the corresponding procedure depending on whether the probability of at least one output candidate is equal to or greater than a preset threshold or whether a difference value between the probabilities of multiple output candidates is equal to or greater than a preset threshold.

For example, as shown in FIG. 4, when the probabilities of respective output candidates of “1. Go to location” do not exceed a threshold (e.g., 0.7), confidence may be calculated as a low value.

Alternatively, as shown in FIG. 5, the probability values of respective output candidates of “1. Find object” do not show a large difference, and thus the confidence of the output candidates may be calculated as a low value.

Finally, the intelligent agent or the robot determines the occurrence of missing knowledge based on the calculated confidence at step S113. That is, when confidence is high, the user's requirement, that is, the command, is executed without asking an additional question. However, as illustrated in FIGS. 4 and 5, when confidence is low, it may be determined that missing knowledge has occurred.

As described above, missing knowledge found at step S110 becomes a direct target for a question. Therefore, as illustrated in FIG. 2, when missing knowledge is captured, the knowledge type (K-type) corresponding thereto is selected at step S120.

Here, K-type refers to the type of missing knowledge that is the cause of uncertainty, and may be defined as shown in the following Table 1.

TABLE 1

| # | Type | Description |
|---|---|---|
| K1 | Identity | Information about who or what a person or thing is |
| K2 | Class | Inclusion relationships of categories |
| K3 | Attributes | Properties and features of the object |
| K4 | Quantities | Quantitative specifications |
| | | (i.e., specification of quantitative information) |
| K5 | Spatial | Spatial relations among entities |
| | layout | |
| K6 | Temporal | Temporal information or sequences |
| | relation | |
| K7 | Contents | Detailed information |
| | | (i.e., detailed information about situation/context) |
| K8 | Procedure | Sequence or method of specific process |
| K9 | Causality | Causal chains of events or states |
| | | (i.e., causal relationships of specific events or states) |
| K10 | Intention | Motivation, aim, or plan of other agents |
| | | (i.e., motivation, purpose or plan of behavior of other |
| | | agents) |
| K11 | Internal | Mental states such as preference or the mood of other |
| | state | agents |

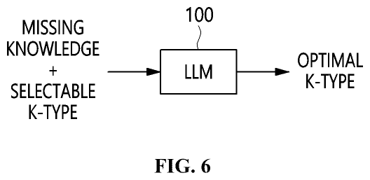

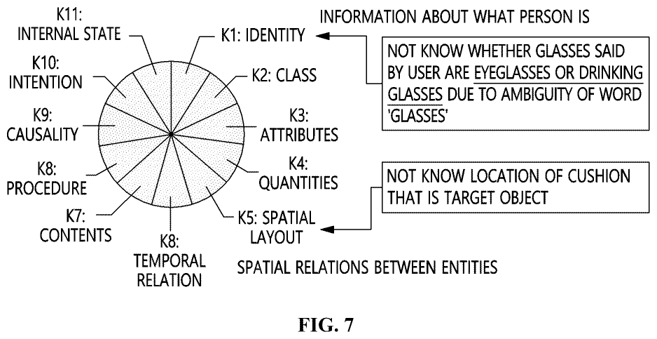

FIG. 6 is a diagram for explaining the flow of the step of selecting a knowledge type corresponding to missing knowledge according to an embodiment, and FIG. 7 is a diagram illustrating an example of selection of a knowledge type corresponding to missing knowledge according to an embodiment.

Referring to FIG. 6, step S120 of selecting the knowledge type according to an embodiment may be performed to input missing knowledge and preset knowledge type (K-type) information to the LLM 100 and search for an optimal knowledge type (K-type) through the LLM 100.

For example, referring to FIG. 7, a cushion that is the item requested by the user in the user's request ‘Bring me a cushion’ is present at several locations, and thus missing knowledge indicating that the location of the cushion cannot be specified is captured. In order to resolve such uncertainty attributable to missing knowledge, K5 (spatial relations among entities) that is the knowledge type (K-type) for the location information (spatial relations) of the cushion is selected.

Furthermore, according to an embodiment, K-type for the missing knowledge may be specified as one type, but may be specified as two or more types depending on the content of the missing knowledge.

Next, referring back to FIG. 2, a question type (Q-type) is selected using the knowledge type (K-type), selected at step S120, at step S130.

Here, the question type (Q-type) refers to a language form for effective question expression, and may be defined as shown in the following Table 2.

TABLE 2

| # | Type | Description |
|---|---|---|
| Q1 | Verification | asking whether true or not (i.e., a question asking |
| | | which is correct or incorrect) |
| Q2 | Case | asking to specify the case (i.e., a question for |
| | specification | specifying which of given cases is true) |
| Q3 | Concept | asking to fulfill insufficient information (i.e., |
| | completion | a question for fulfilling insufficient |
| | | information) |
| Q4 | Feature | asking to describe properties |
| | specification | (i.e., a question asking descriptive properties |
| | | of the target) |
| Q5 | Quantification | asking quantitative specification |
| | | (i.e., a question for specifying quantitative |
| | | information) |
| Q6 | Definition | asking to state the nature, scope, or meaning |
| | | (i.e., a question for requesting description |
| | | of nature, scope or meaning of the target) |
| Q7 | Comparison | asking about similarities or dissimilarities |
| | | between groups (i.e., a question asking |
| | | similarities and dissimilarities between |
| | | groups) |
| Q8 | Interpretation | asking to explain the meaning or details (i.e., a |
| | | question asking the meaning or details of the |
| | | target or state) |
| Q9 | Cause | asking what the antecedent of the causality is |
| | elucidation | (i.e., a question asking the antecedent element |
| | | of causality, that is, the cause thereof) |
| Q10 | Intention | asking about motivation or goal orientation |
| | disclosure | (i.e., a question asking the motivation or |
| | | purpose of behavior) |
| Q11 | Result | asking what the outcome of the causality is |
| | account | (i.e., a question asking the result of the |
| | | causality) |
| Q12 | Method | asking the procedure, sequence, or tools (i.e., a |
| | explication | question asking the procedure, sequence or |
| | | tools (methods) of the process) |
| Q13 | Expectation | asking a belief or case in the future (i.e., a |
| | | question asking the belief or case in the future) |
| Q14 | Judging | asking an opinion or evaluation about something |
| | | (i.e., a question asking the opinion or |
| | | evaluation of a target) |

In Table 2, as the question number Q #increases, the complexity and depth of a question form increase, and thus a relatively high-level cognitive process may be required. For example, the question form of “Q14: judging” may be at a level higher than that of the question form of “Q1: verification”.

Here, step S130 of selecting the question type according to the embodiment may be performed to select a question type based on the probability of deriving the selected knowledge type from among preset question types.

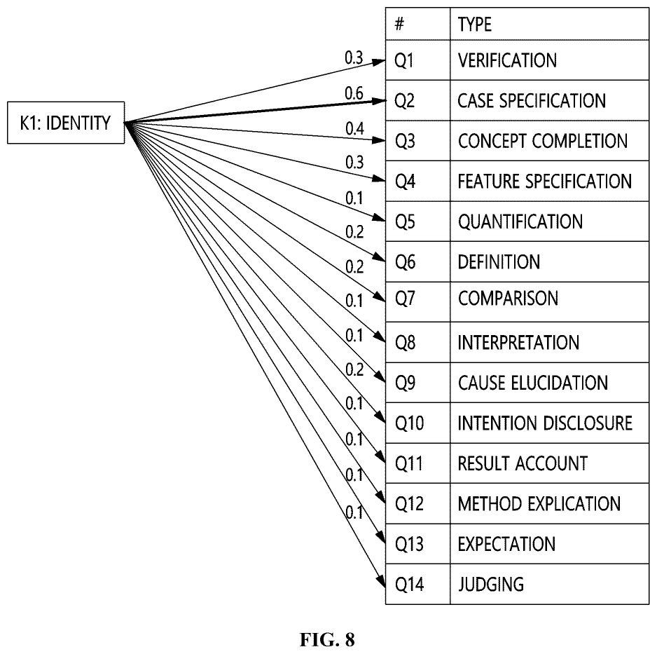

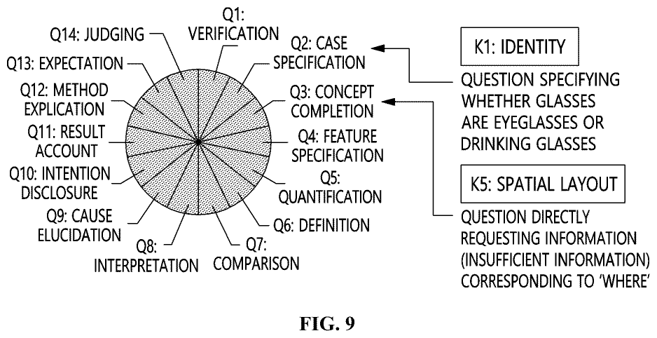

FIGS. 8 and 9 are diagrams illustrating an example of question type selection according to an embodiment.

Referring to FIG. 8, Q-type that is the question type widely utilized to obtain K-type is selected.

For example, Q-type corresponding to “Q2: case specification” may be selected at the highest probability so as to satisfy K-type knowledge corresponding to “K1: identity”. In other words, in order to satisfy “K1: identity” knowledge indicating whether glasses means eyeglasses or drinking glasses, it is determined that the question type Q2 which asks the user to specify which one of eyeglasses and drinking glasses ‘glasses’ refers to is suitable.

Similarly, referring to FIG. 9, in order to satisfy K-type knowledge indicating “K5: spatial layout”, it is determined that the question type “Q3: concept completion” for directly asking location information using ‘Where’ is suitable at the highest probability.

However, according to another embodiment, a method for selecting Q-type may be performed to select the question type (Q-type) based on criteria other than probability, such as additional contextual information (e.g., limited only to queries and answers regarding cause-and-effect or sequence) or constraints (e.g., limited only to simple questions in Q1 to Q5).

Referring back to FIG. 2, a question is generated based on the above-described K-type and Q-type at step S140.

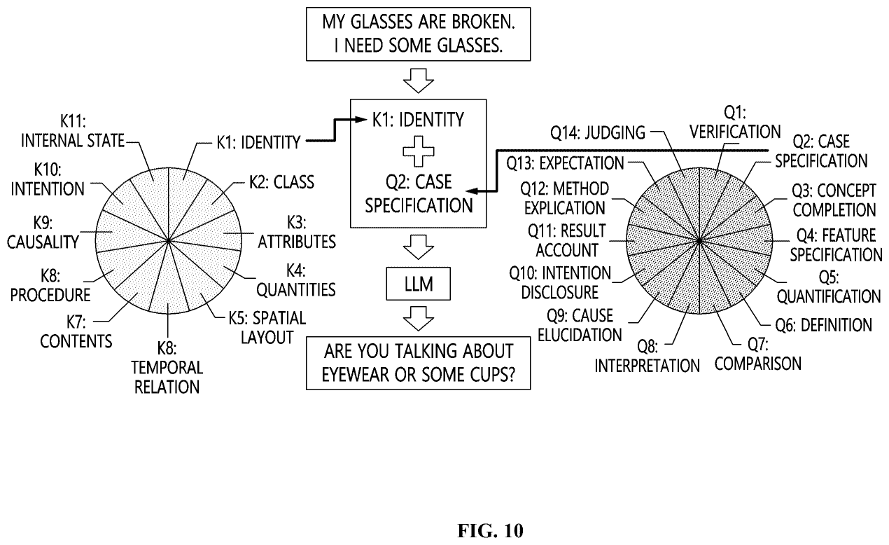

FIG. 10 is a diagram for explaining the step of generating a question based on K-type and Q-type according to an embodiment.

Referring to FIG. 10, step S140 of generating a question according to an embodiment may be performed to input information about the selected knowledge type and information about the selected question type to the LLM 100 through a prompt, and to automatically generate a question through the LLM 100.

Here, the prompt, which is the input of the LLM, refers to a method for describing to a generative model in natural language what action the generative model should perform, and producing a result desired by the user (person). Even if the same LLM is used, different results are obtained depending on how the prompt is input, and thus it may be determined that the importance of the prompt is high.

Here, the prompt may generally be composed of four elements as shown the following Table 3. However, all of four components are not necessary, and may vary depending on the tasks and situations.

TABLE 3

| Element | Main content |
|---|---|
| Indication | Detailed target, specific task, etc. |
| Context | Background information necessary for understanding |
| | a task |
| Input data | Input data for target desired to be answered |
| Output indicator | Type or output format of result (output) |

In Table 3, ‘Instruction’ denotes a detailed target, a specific task target, or the like desired to be performed by the LLM, and may be regarded as automatic question generation in an embodiment.

Further, ‘Context’ denotes background information necessary for understanding tasks, and provides, for example, simple description of a question or the summary of related information. In an embodiment, as K-type information and Q-type information are provided as context information, information about the form of the question, as well as the purpose and intention of question generation, may also be input.

Further, ‘Input data’ may be input data related to a target desired to be answered, and may be the command of the user (or the content of exchanged conversations) in the present disclosure.

Finally, ‘Output indicator’ may denote an output (i.e., a result), and may correspond to a question sentence in an embodiment.

The question sentence may be generated in various forms through appropriate adjustment of hyperparameters in conformity with the conversational context (e.g., casual conversation) and purpose (e.g., surveys). For example, in the case of temperature, which controls the creativity and randomness of the output, a lower temperature value enables more deterministic and conservative answer (response) results to be derived, whereas a higher temperature value enables more diverse and creative answer (response) results to be generated.

Referring back to FIG. 2, the automatic question generation method according to the embodiment may further include step S150 of, after the generated question is output, analyzing the answer input from the user and determining whether the answer satisfies the knowledge type.

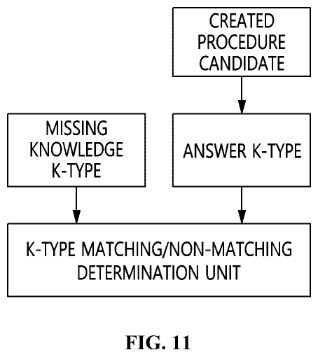

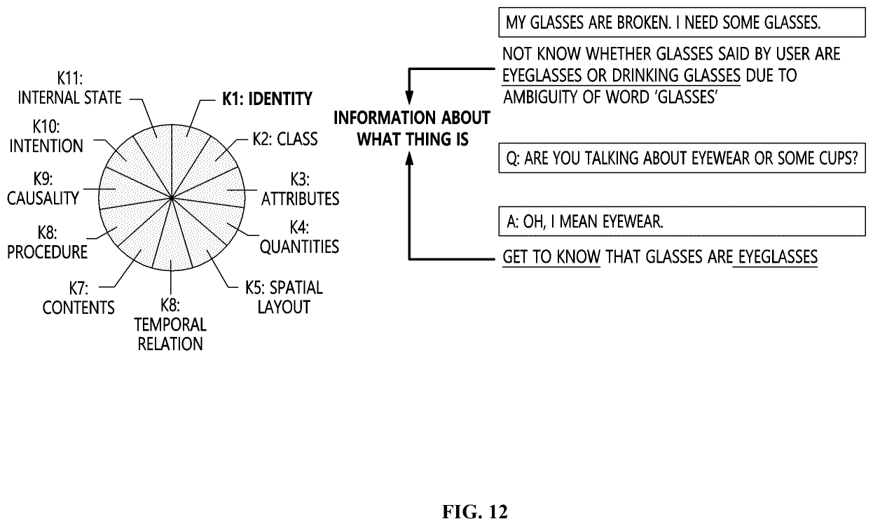

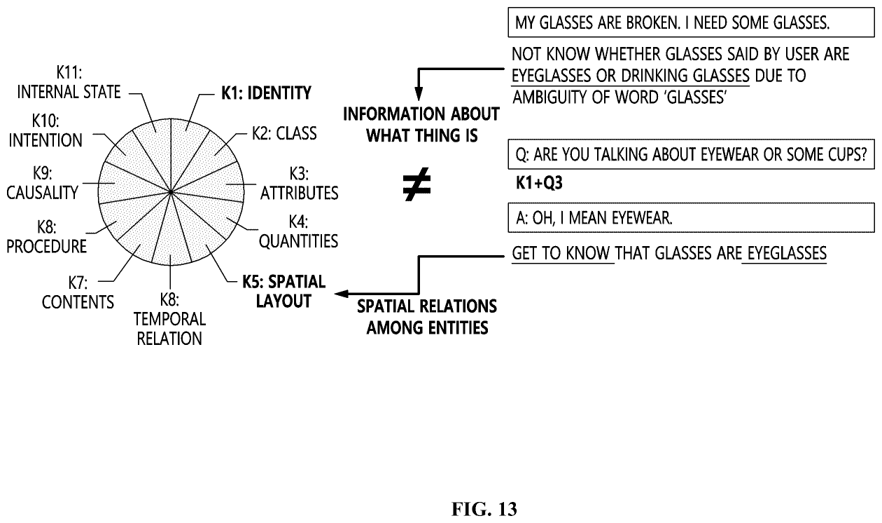

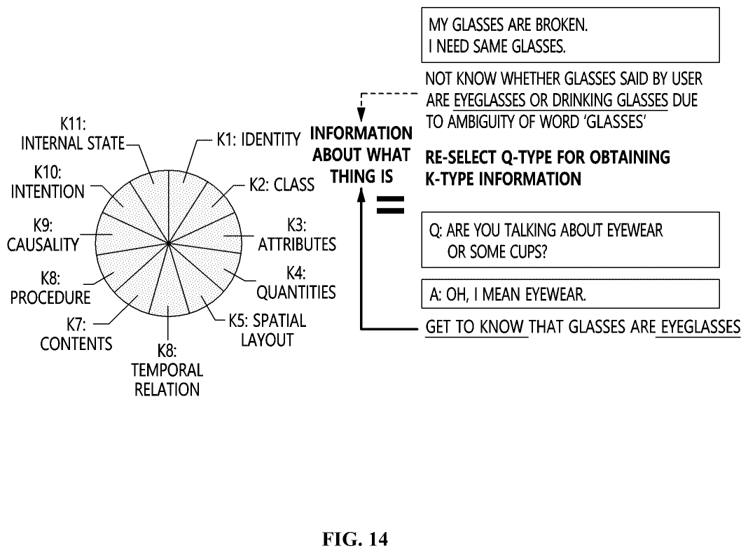

FIG. 11 is a diagram for explaining the step of determining whether K-type of a question and K-type of an answer match each other according to an embodiment, FIG. 12 is a diagram illustrating an example of the case where an answer satisfies K-type for missing knowledge according to an embodiment, FIG. 13 is a diagram illustrating an example of the case where an answer does not satisfy K-type for missing knowledge according to an embodiment, and FIG. 14 is a diagram illustrating an example of a process of re-selecting Q-type and generating an additional question when an answer does not satisfy K-type according to an embodiment.

Referring to FIG. 11, the intelligent agent or the robot asks a question generated through the LLM to a user and obtains an answer to the question from the user.

Then, whether the answer satisfies the knowledge type may be determined depending on whether a keyword found in the answer input from the user matches one of detailed procedures created by the LLM for processing the requirement of the user.

Here, when the answer satisfies the knowledge type (K-type), the probability of a specific output candidate increases, and thus the confidence of the corresponding procedure increases, with the result that uncertainty attributable to missing knowledge is resolved.

For example, referring to FIG. 12, the case where the answer satisfies K-type for the missing knowledge is illustrated. Since the keyword ‘eyewear’ extracted from the answer is one of procedure output candidates created by the LLM, it is determined that K-type (K1: Identity) matches that of the answer, and thus K-type of the answer satisfies K-type for the missing knowledge. That is, uncertainty arising from not knowing whether glasses refers to eyeglasses or drinking glasses is resolved through the answer identifying that the glasses are eyeglasses.

On the other hand, referring to FIG. 13, the case where an answer does not satisfy K-type for missing knowledge is illustrated. In this case, because keywords (e.g., living room, table, etc.) extracted from the answer do not match procedure output candidates created by the LLM, it is determined that the K-types of the question and the answer do not match each other. For example, as an answer to the question addressing K1 (identity) arising from not knowing whether glasses refers to eyeglasses or drinking glasses, spatial layout information (K5) that is location information of glasses becomes known, whereby mismatch between the K-type of the question (K1) and the K-type of the answer (K5) occurs, thus making it impossible to resolve uncertainty.

In this way, the case where the answer does not satisfy the K-type requested in the question may be regarded as the case where the user misunderstands the question to make an unsuitable answer or as the case where Q-type is falsely selected.

Therefore, when the answer input from the user does not satisfy the knowledge type, the automatic question generation method according to the embodiment may re-perform a process starting from step S130 of selecting a question type.

That is, referring to FIG. 14, the K-type cannot be satisfied by the Q3 (question for fulfilling insufficient information)-type question initially selected to obtain missing knowledge), and thereby a Q-type re-selection procedure is performed.

Here, when step S130 of selecting the question type is re-performed, the next question type may be selected in descending order of probabilities for deriving the selected knowledge type from among the preset question types. That is, when the question type (Q-type) is re-selected, a question type having the next rank is selected based on probabilities.

That is, an additional question is generated using the LLC based on the re-selected Q-type information and the K-type information. The intelligent agent or the robot which obtain an answer through the generated additional question re-checks whether the new answer satisfies the K-type at step S150, and repeatedly performs a procedure starting from step S130 of re-selecting Q-type until the new answer satisfies the K-type when the new answer does not satisfy the K-type.

Meanwhile, referring back to FIG. 2, the automatic question generation method according to the embodiment may further include step S160 of determining whether additional missing knowledge is detected in the answer input from the user. That is, when it is determined that the answer satisfies the K-type, whether an additional question is required is determined by checking presence or non-presence of new missing knowledge.

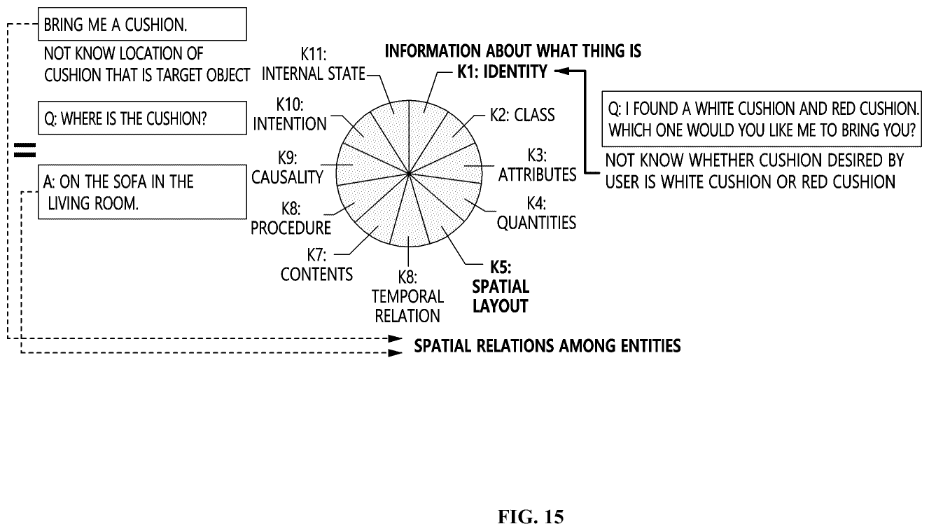

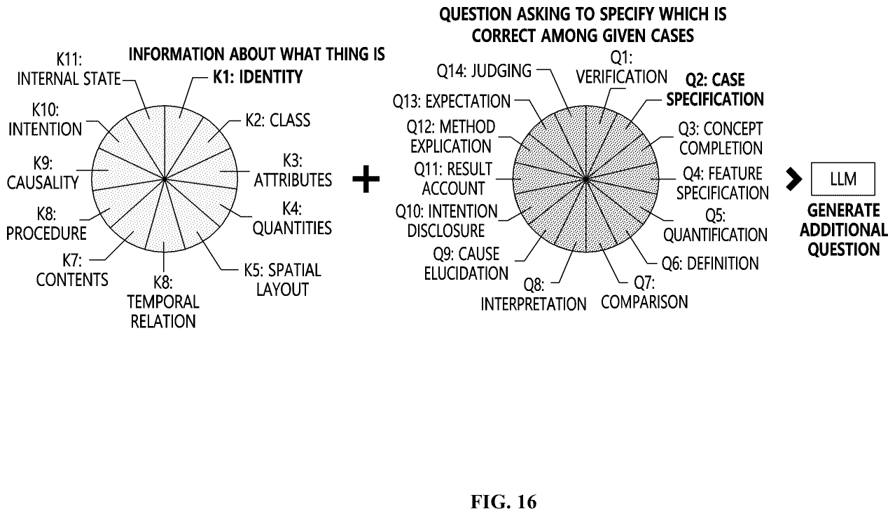

FIG. 15 is a diagram illustrating an example of selection of K-type for added missing knowledge according to an embodiment, and FIG. 16 is a diagram illustrating an example of generation of an additional question based on additionally selected K-type and Q-type information.

Referring to FIG. 15, the case where an answer obtained through a question satisfies K-type (K5) for missing knowledge is satisfied, but new missing knowledge occurs in the answer.

In this way, as missing knowledge is detected in the answer input from the user, a process starting from step S120 of selecting a knowledge type may be re-performed.

That is, K-type for the added missing knowledge is selected at step S120, as shown in FIG. 15, Q-type is selected in the same manner as the previous process, as shown in FIG. 16, and step S140 of generating an additional question using the LLM is performed. This process may be repeated until uncertainty is resolved.

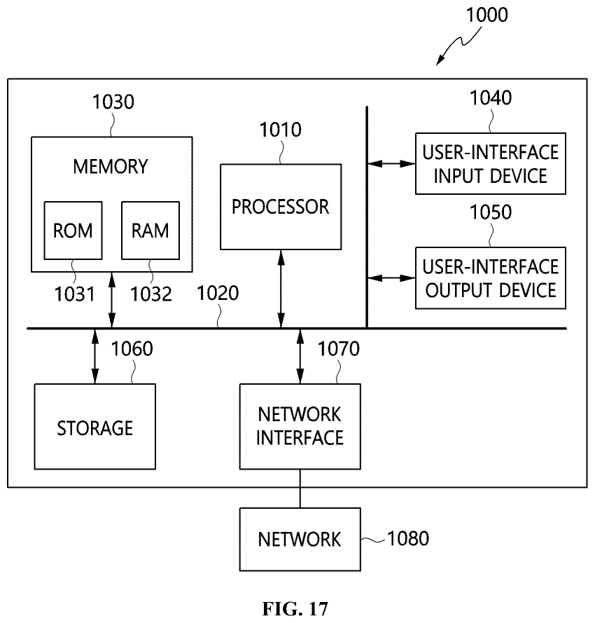

FIG. 17 is a diagram illustrating the configuration of a computer system according to an embodiment.

An automatic question generation apparatus according to an embodiment may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032.

According to embodiments, an intelligent agent or a robot may determine a time point, at which a question is required, and conversation content, and automatically generate a question so as to resolve uncertainty, thus enabling responses suitable for a current situation, rather than making monochrome conversations based on preset rules.

Further, according to embodiments, it is possible to continue to exchange queries and responses based on a question model based on a human question process, unlike a rule-based model, even in an unpredictable situation, thus minimizing a person's intervention.

Furthermore, according to embodiments, when the present disclosure is applied to surveys, customer service complaint handling, etc. where a query-and-response process is crucial, it is expected to not only reduce the burden of customer interaction tasks but also enable efficient query-and-response exchanges.

Although the embodiment of the present disclosure has been disclosed, those skilled in the art will appreciate that the present disclosure can be implemented as other concrete forms, without departing from the scope and spirit of the disclosure as disclosed in the accompanying claims. Therefore, it should be understood that the exemplary embodiment is only for illustrative purpose and do not limit the scope of the present disclosure.

What is claimed is:

1. An automatic question generation method, comprising:
detecting uncertainty by identifying presence or non-presence of missing knowledge and content of the missing knowledge based on environment information and conversation content;
as uncertainty is detected, selecting a knowledge type for the missing knowledge;
selecting a question type corresponding to the selected knowledge type; and
generating a question by combining the knowledge type with the question type.

2. The automatic question generation method of claim 1, wherein detecting the uncertainty comprises:
creating detailed procedures for processing a requirement of a user based on the conversation content and the environment information through task planning;
calculating confidence based on a probability of at least one output candidate for each procedure included in the created detailed procedures; and
determining occurrence of missing knowledge based on the calculated confidence.

3. The automatic question generation method of claim 1, wherein calculating the confidence comprises:
calculating the confidence of the corresponding procedure depending on whether the probability of the at least one output candidate is equal to or greater than a preset threshold or whether a difference value between probabilities of multiple output candidates is equal to or greater than a preset value.

4. The automatic question generation method of claim 1, wherein selecting the knowledge type comprises:
inputting the missing knowledge and preset knowledge type information to a large language model and searching for an optimal knowledge type through the large language model.

5. The automatic question generation method of claim 1, wherein selecting the question type comprises:
selecting the question type based on a probability of deriving the selected knowledge type from among preset question types.

6. The automatic question generation method of claim 1, wherein:
generating the question comprises:
inputting information about the selected knowledge type and information about the selected question type to a large language model through a prompt, and automatically generating a question through the large language model, and
the prompt includes instruction that is a target of a task, context that is background information of the task, input data that is a command of the user, and an output indicator that is a question sentence.

7. The automatic question generation method of claim 2, further comprising:
after the generated question is output, analyzing an answer input from the user, and determining whether the answer satisfies the knowledge type.

8. The automatic question generation method of claim 7, wherein determining whether the answer satisfies the knowledge type comprises:
determining whether the answer satisfies the knowledge type depending on whether a keyword found in the answer input from the user matches one of detailed procedures for processing the requirement of the user.

9. The automatic question generation method of claim 7, further comprising:
when the answer input from the user does not satisfy the knowledge type, re-performing a process starting from selecting the question type,
wherein re-performing selecting the question type comprises selecting a next question type in descending order of probabilities of deriving selected knowledge types from among preset question types.

10. The automatic question generation method of claim 7, further comprising:
re-performing a process starting from selecting the knowledge type as missing knowledge is detected in the answer input from the user.

11. An automatic question generation apparatus, comprising:
a memory configured to store at least one program; and
a processor configured to execute the program,
wherein the program is configured to detect uncertainty by identifying presence or non-presence of missing knowledge and content of the missing knowledge based on environment information and conversation content, as uncertainty is detected, select a knowledge type for the missing knowledge, select a question type corresponding to the selected knowledge type, and generate a question by combining the knowledge type with the question type.

12. The automatic question generation apparatus of claim 11, wherein the program is configured to, in detecting the uncertainty, create detailed procedures for processing a requirement of a user based on the conversation content and the environment information through task planning, calculate confidence based on a probability of at least one output candidate for each procedure included in the created detailed procedures, and determine occurrence of missing knowledge based on the calculated confidence.

13. The automatic question generation apparatus of claim 11, wherein the program is configured to, in calculating the confidence, calculate the confidence of the corresponding procedure depending on whether the probability of the at least one output candidate is equal to or greater than a preset threshold or whether a difference value between probabilities of multiple output candidates is equal to or greater than a preset value.

14. The automatic question generation apparatus of claim 11, wherein the program is configured to, in selecting the knowledge type, input the missing knowledge and preset knowledge type information to a large language model and search for an optimal knowledge type through the large language model.

15. The automatic question generation apparatus of claim 11, wherein the program is configured to, in selecting the question type, select the question type based on a probability of deriving the selected knowledge type from among preset question types.

16. The automatic question generation apparatus of claim 11, wherein:
the program is configured to, in generating the question, input information about the selected knowledge type and information about the selected question type to a large language model through a prompt, and automatically generate a question through the large language model, and
the prompt includes instruction that is a target of a task, context that is background information of the task, input data that is a command of the user, and an output indicator that is a question sentence.

17. The automatic question generation apparatus of claim 12, wherein the program is configured to:
after the generated question is output, analyze an answer input from the user, and determine whether the answer satisfies the knowledge type, and
determine whether the answer satisfies the knowledge type depending on whether a keyword found in the answer input from the user matches one of detailed procedures for processing the requirement of the user.

18. The automatic question generation apparatus of claim 17, wherein the program is configured to:
when the answer input from the user does not satisfy the knowledge type, re-perform a process starting from selecting the question type, and
in re-performing selecting the question type, select a next question type in descending order of probabilities of deriving selected knowledge types from among preset question types.

19. The automatic question generation apparatus of claim 18, wherein the program is configured to re-perform a process starting from selecting the knowledge type as missing knowledge is detected in the answer input from the user.

20. An automatic question generation method, comprising:
creating detailed procedures for processing a requirement of a user based on conversation content and environment information;
calculating confidence based on a probability of at least one output candidate for each procedure included in the created detailed procedures;
determining occurrence of missing knowledge based on the calculated confidence;
as uncertainty is detected, selecting a knowledge type for the missing knowledge using a large language model;
selecting a corresponding question type based on a probability of deriving the selected knowledge type;
generating a question by combining the knowledge type with the question type;
after the generated question is output, analyzing an answer input from the user, and determining whether the answer satisfies the knowledge type; and
when the answer satisfies the knowledge type, detecting presence or non-presence of additional missing knowledge in the answer input from the user,
wherein when the answer input from the user does not satisfy the knowledge type, a process starting from selecting the question type is re-performed, and
wherein when additional missing knowledge is detected in the answer input from the user, a process starting from selecting the knowledge type is re-performed.
